(19) United States
(12) Patent Application Publication
(10) Pub. No.: US 2005/0228794 A1
(43) Pub. Date: Oct. 13, 2005

(54) Method and apparatus for virtual content access systems built on a content routing network

(76) Inventors: Julio C. Navas, Concord, CA (US); Ying Shu, Los Altos, CA (US)

Correspondence Address: GLENN PATENT GROUP, 3475 EDISON WAY, SUITE L, MENLO PARK, CA, 94025, US

(21) Appl. No.: 11/093,924

(22) Filed: Mar. 29, 2005

Related U.S. Application Data
(60) Provisional application No. 60/558,036, filed on Mar. 30, 2004.

(51) Int. Cl. G06F 17/30

(52) U.S. Cl. 707/10

(57) ABSTRACT

The invention comprises a method and apparatus for information management of a network database having distributed data sources. One embodiment of the invention comprises the steps of decomposing a query into at least one network message for transmission using characteristic routing over a network only to data sources relevant to the query, the query specifying at least one data source; receiving a reply message in response to the network message over the network; and generating a result for the query from the reply message. The query is received in a database language and the generated result is in the database language. The query further specifies a period of time during which the query is valid.

### CROSS REFERENCE TO RELATED APPLICATIONS

This application claims benefit of U.S. provisional patent application Ser. No. 60/558,036, filed on Mar. 30, 2004 and U.S. utility application Ser. No. 10/096,209, filed Mar. 11, 2004, which are herein incorporated in their entirety by this reference thereto.

### BACKGROUND OF THE INVENTION

1. Technical Field

The invention relates to computer networks. More particularly, the invention relates to a method and apparatus for virtual access systems built on a content routing network.

2. Description of the Prior Art

A trend in the information, communication, and automation industries is for increasingly distributed solutions. Recent examples of this trend are the proposal for networked sensors and the suggestion that large groups of such data sources could form large distributed information systems referred to as networks of data sources. In the article Next Century Challenges: Mobile Networking for Smart Dust (published in MobiComm 1999), authors Kahn et al. discuss an example of a distributed network of data sources in the form of a network of sensors.

The primary idea of a network of data sources is that individual data sources, or perhaps small groups of data sources, are connected to computer networks, using standard communications protocols, such as the Internet Protocol (IP). Other devices on the network can to access the data provided by the data sources, either individually or in aggregate depending on the application. In the most ambitious proposals, wireless networks of data sources define their topologies dynamically as they are deployed, and continuously redefine their links and routing schemes to account for new and failing nodes and optimal power management. Rudimentary forms of networks of data sources are already being used in some industrial process control systems, and future applications for networks of data sources are widely predicted in many domains.

Historically, there are two main publication and subscription techniques:
1) hub-based; and
2) bus-based.

Hub-based publication and subscription uses a central server as a rendezvous point. This central server often maintains message queues by storing packets that cannot be immediately consumed. Security is maintained by the hub by controlling the list membership.

To subscribe, users access the hub and are put on an appropriate list, depending on whether they subscribed to content or source-based streams. The central server keeps track of subscriber lists.

When publishing, a publisher transmits streams to the hub directly. The central server hub then forwards copies of the stream packets to appropriate subscribers on the content or source list.

In bus-based publication and subscription, multiple hub servers are used. As with the hub-based method, security and storage are handled at each distributed hub.

When subscribing, a user accesses the local hub server and is placed on source or content lists.

When publishing, a publisher transmits information to the local hub. The hub broadcasts the stream packets to all of the other hubs. Each hub then forwards stream packets to local subscribers, as with a centralized hub.

One approach is to retrieve documents by using only simple Boolean search criteria, instead of SQL. This approach does not permit complex SQL search queries and can used to search static text documents, not SQL databases.

The state of the art does not support a distributed data model with all data centralized, and deals with streamlining of incoming (new) documents that are not initially in a static, persisted database. Such approach is only concerned with relevance to a single item or document, and not with conditions across multiple items or documents.

One approach trades off the precision of results with network overhead. It applies to streaming data sources and is used to distribute filters at data sources. The applications for network monitoring and sensor networks are simple aggregation functions only.

Another approach builds on a scalable mechanism for distributed information retrieval sets updatabases that summarize the holdings on particular topics of other databases. Index brokers can index the contents of primary databases and other index brokers. Each primary database and index broker operates in concert with one or more site brokers, which store the generator queries of all index brokers that index their associated database, and are responsible for keeping indices current. A topic broker describes every site and index broker. However, this system pre-computes queries and the segment tree is a balanced binary tree. The method uses intermediate software components, such as brokers, to process requests to search static text documents but not SQL databases.

Another system builds a distributed index for multi-dimensional data and divides a geographic area into zones. It maps a multi-attribute event to a geographic zone and a range query to a zone code prefix. However, this system divides the geographic extent of a sensor field into zones that are represented as binary trees, and splits the range into sub-queries, each of which falls in a zone. The queries are multi-dimensional.

Therefore, it would be advantageous to build a system for virtual content access systems on a content routing network.

### SUMMARY OF THE INVENTION

The invention comprises a method and apparatus for information management of a network database having distributed data sources. The invented method comprises the steps of decomposing a query into at least one network message for transmission using characteristic routing over a network only to data sources relevant to the query, the query specifying at least one data source; receiving a reply message in response to the network message over the network; and generating a result for the query from the reply message. The query is received in a database language and the generated result is in the database language. The query further specifies a period of time during which the query is valid.

The query specifies no data-specific constraints on returned values on one or more requested topics. The query further specifies at least one data-specific constraint on returned values on one or more requested topics and requests an immediate response.

In the invention, a machine readable medium contains instruction data which, when executed on a data processing system, causes the system to perform a method for information management of a network database having distributed data sources where the method comprises the steps of decomposing a query into at least one network message for transmission using characteristic routing over a network only to data sources relevant to the query, the query specifying a period of time during which the query is valid, and the query specifying no data-specific constraints on returned values on one or more requested topics; receiving a reply message in response to the network message over the network; and generating a result for the query from the reply message. The query is received in a database language, and the generated result is in the database language. Furthermore, the query specifies at least one data source.

The query specifies no specific data source and the data sources group data into ranges or sets. The query specifies a range request.

In the invention, an apparatus for information management of a network database having distributed data sources comprises means for decomposing a query into at least one network message for transmission using characteristic routing over a network only to data sources relevant to the query, the query specifying at least one data source or requesting data from multiple data sources within a specific period of time; means for receiving a reply message in response to the network message over the network; and means for generating a result for the query from the reply message.

The query is received in a database language and the generated result is in the database language.

The query also can specify a period of time during which the query is valid.

The query also can specify no data-specific constraints on returned values on one or more requested topics.

The query also can specify at least one data-specific constraint on returned values on one or more requested topics.

Further the query can request an immediate response.

### BRIEF DESCRIPTION OF THE DRAWINGS

FIG. 1 is a block diagram that illustrates a virtual content access system according to the invention;

FIG. 2 is a flow diagram showing a method of accessing the virtual content access system built on a content routing network according to the invention;

FIG. 3 is a flow diagram showing a method for accessing the virtual content access system built on a content routing network according to the invention;

FIG. 4 is a flow diagram showing a method for accessing a virtual content access system built on a content routing network according to the invention;

FIG. 5 is a flow diagram showing a method of accessing a virtual content access system built on a content routing network according to the invention;

FIG. 6 is block diagram showing a system of subscribing to a topic based on the virtual content access system built on a content routing network according to the invention;

FIG. 7 is a block diagram showing a system of subscribing to a source on the virtual content access system built on a content routing network according to the invention;

FIG. 8 is a block diagram showing a system of mixed subscription on the virtual content access system built on a content routing network according to the invention;

FIG. 9 is a block diagram showing a system of publishing to source subscribers on the virtual content access system built on a content routing network according to the invention; and

FIG. 10 is a block diagram showing a system of publishing to topic subscribers on the virtual content access system built on a content routing network according to the invention.

### DETAILED DESCRIPTION OF THE INVENTION

Definitions:

| | |
|---|---|
| Characteristic | Represented as a string of arbitrary length. The string |
| | is not limited to alphanumeric characters and can be |
| | composed of any binary value. A characteristic is |
| | essentially an identifier that represents a distinct group. |
| | Assigning a characteristic to a node is equivalent to |
| | assigning that node membership in the group identified |
| | by the characteristic. |
| QP | Query Processor |
| DQR | Designated Query Router |
| DSM | Data Source Manager |
| VODS | Virtual Operational Data Store |
| VCAS | Virtual Content Access System |
| Publisher | A provider of information |
| Subscriber | A requestor of information |

The content-based routing approach to a virtual content access system according to the invention does not need a large central server hardware. Messages are finely targeted when published and are sent directly to the appropriate subscribers. This approach is more network resource friendly than network-based approaches. This is especially important over a WAN. The preferred embodiment automatically configures network connections and allows the system to network together automatically. The automation works equally well over a WAN or a LAN environment.

The underlying indexing capabilities must be extended to enable range data requests and reduce the memory and control information transmission overhead on a hash-based content routing network to realize a VCAS. The invention handles range requests and bit vector size reduction through the use of data grouping. Data items that need to be indexed are grouped into ranges or sets. Each range or set is then assigned a group identification. Instead of indexing each individual data item, the corresponding group identification is indexed.

The invention eliminates update traffic from large omniscient data sources or data sources that cannot be indexed. Such data sources may have such large amounts of varied data that they fill a summary bit vector, or the data source may not be reachable for indexing purposes. In both cases, the cost of providing continuous index updates from the sources outweighs the benefit derived from the updates and, therefore, it is preferable to eliminate the update traffic.

The invention also reduces control and run-time overhead by distinguishing between primary and secondary data sources. Both a primary data source and one or more of its backup or secondary data sources are connected to the network. In such cases, instead of routing a query to all replicated instances of the same data and returning multiple identical sets of results, it is more efficient to interact only with the primary data source for most queries and to interact with the secondary data sources only when the primary fails.

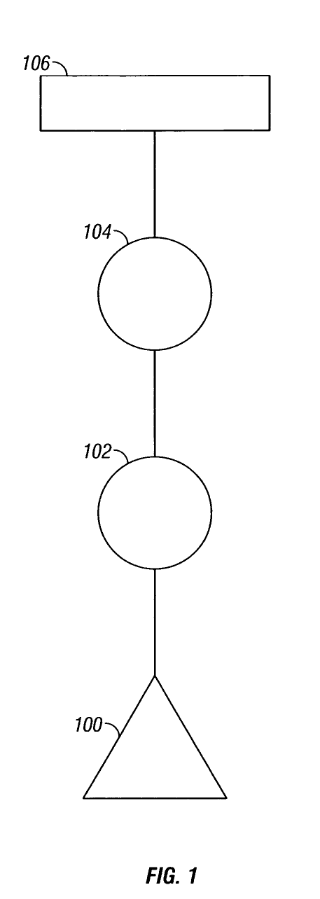

FIG. 1 is a diagram that illustrates a virtual content access system according to the invention. The virtual content access system comprises a data source manager 100, a dynamic query router 102, a query processor 104, and an administration dashboard 106.

The data source manager (DSM) 100 is a small piece of software that resides close to each data source. It provides data access to a variety of data sources, e.g. relational databases, Excel® spreadsheets, legacy mainframe systems, radio frequency ID (RFID) readers, etc.

The dynamic query router (DQR) 102 is the heart of the information integration network and communicates with the DSM 100 and the rest of the components in the network. Similar to a network data router, a dynamic query router 102 forms a network of information about where item-level detail data live. As queries are executed, the dynamic query routers create dynamic data flow paths that route the query quickly to only those data sources that have information on that query item.

The query processor (QP) 106 is the consolidated query entry and exit point of the Integrator. The query processor 106 provides three key functions to the system:
1) standard interfaces to support front-end applications and tools;
2) a single system view of disparate data sources; and
3) query optimization.

The administration dash board (AD) 108 provides an easy-to-use, Web-based interface to manage the entire information integration network. Through this interface, a user can access all of the normal administration tasks necessary to keep the system performing optimally.

Each data source associated with a DSM 100 can be considered as a publisher that has the information a subscriber needs. The publisher changes the content periodically. The changes are reflected in bit vectors through either a partial or total rescan of the database, depending on the scope of the updates. The DQR 104 stores the bit vectors and can aggregate them. The routers form a network with edge routers having more detailed bit vector information, and with intermediate routers containing summarized versions of the bit vectors. In this way, a content access system based on the content in the bit vectors is formed.

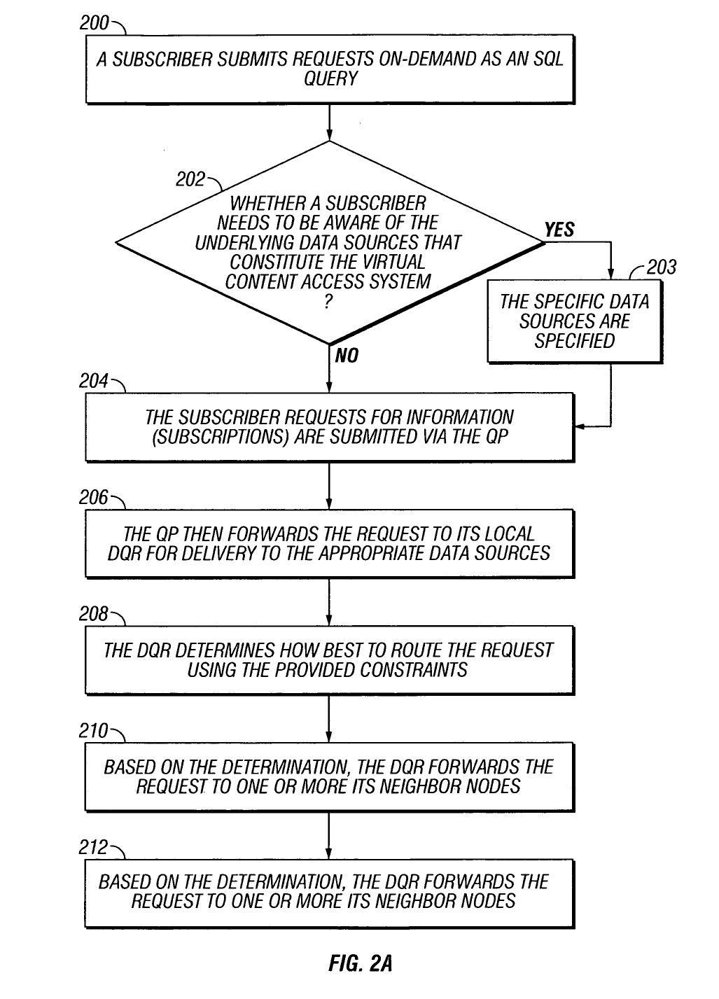

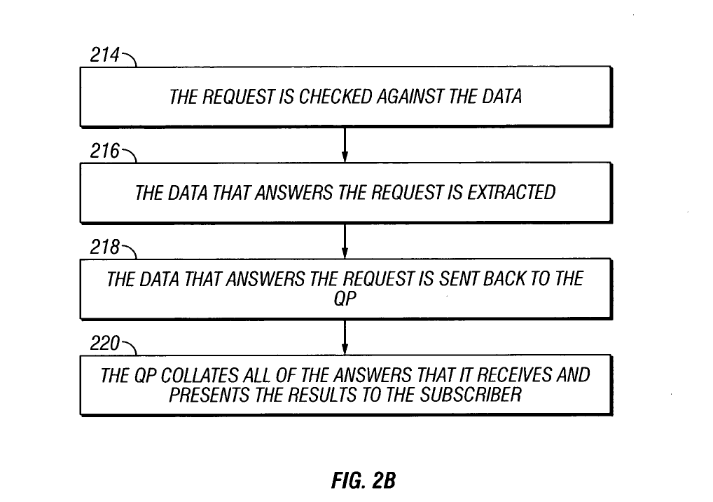

FIG. 2 is a flow diagram showing a method of accessing the virtual content access system built on a content routing network according to the invention.

A subscriber submits requests on-demand as an SQL query 200. Depending on whether a subscriber needs to be aware of the underlying data sources that constitute the virtual content access system 202, the specific data sources that should respond to the request may or may not be specified.

If a subscriber does not need to be aware of the underlying data sources that constitute the virtual content access system, the specific data sources are not specified. For example, a normal SQL query as below can be issued:
SELECT Employee.Name
FROM Employee
WHERE Employee.Dept=“Marketing”;
If a subscriber is aware of the underlying data sources that constitute the virtual content access system, the specific data sources are specified 203. For example, an SQL query as below can be issued:
SELECT Employee.Name
FROM Employee
WHERE Employee.Dept=“Marketing”
DATA_SOURCE_ID=“Main_HQ_Computer”;

The subscriptions are submitted via the QP 204. The QP then forwards the request to its local DQR for delivery to the appropriate data sources 206. The DQR determines how best to route the request using the provided constraints 208. Based on the determination, the DQR forwards the request to one or more its neighbor nodes 210.

The request is then routed multi-hop through the DQR network as it is forwarded to the set of data sources 212. Only data sources that meet the constraints are forwarded a copy of the request. When the request reaches the publishers, it is checked against the data 214. The data that answer the request are Extracted 216 and sent back to the QP 218. The QP collates all of the answers that it receives and presents the results to the subscriber 220.

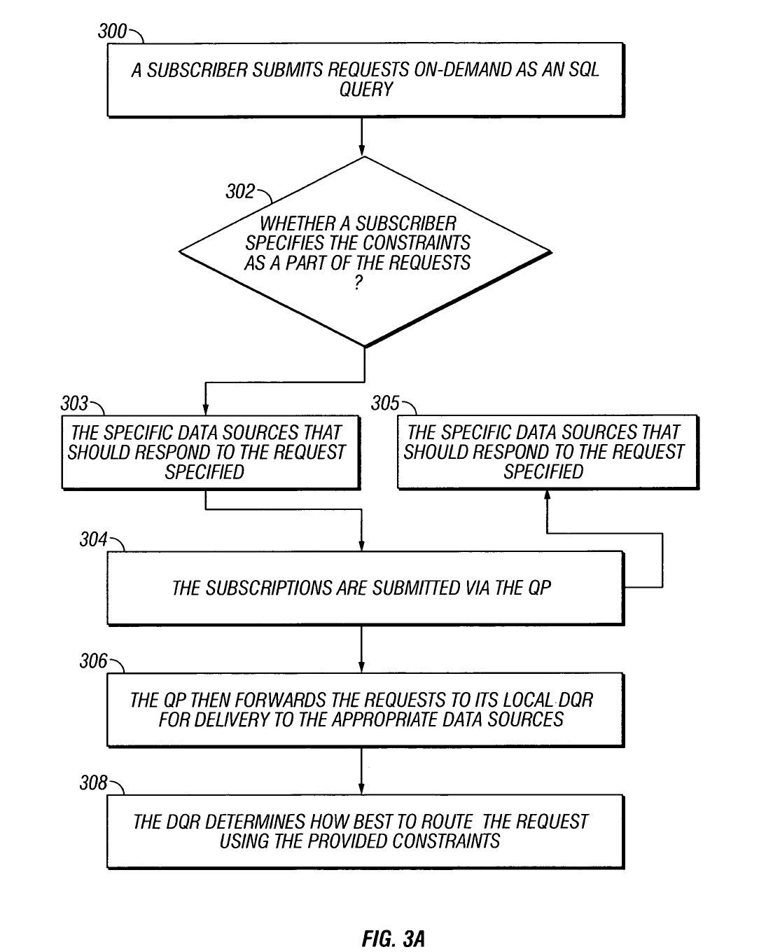

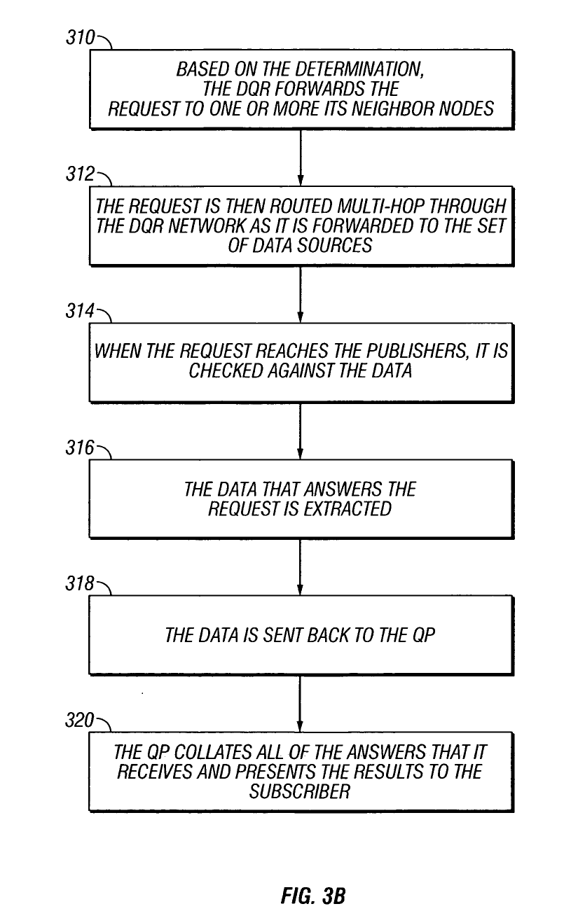

FIG. 3 is a flow diagram showing a method for accessing the virtual content access system built on a content routing network according to the invention.

A subscriber submits requests on-demand as an SQL query 300. Depending on whether a subscriber specifies the constraints as a part of the requests 302, the specific data sources that should respond to the request may or may not be specified.

If the subscriber specifies the constraints as a part of the request, then only requested topics of information are provided. For instance, the subscriber specifies that one wants to receive all information relating to a particular subject area. In relational database terms, this is applied to a table within a relational schema. For example, this can be done in the following manner (note the lack of a WHERE clause):
SELECT *
FROM Employee;

If the subscriber is aware of the individual data sources that underlie the VCAS system, an unconstrained SQL query for a particular topic is issued. In addition, the specific data source that should respond to the request is specified. Only the data source specified by the subscriber is forwarded a copy of the request. For example, this can be done via an SQL query similar to the following:
SELECT *
FROM Employee
DATA_SOURCE_ID=“Main_HQ_Computer”;

The subscriptions are submitted via the QP 304. The QP then forwards the request to its local DQR for delivery to the appropriate data sources 306. The DQR determines how best to route the request using the provided constraints 308. Based on the determination, the DQR forwards the request to one or more its neighbor nodes 310.

The request is then routed multi-hop through the DQR network as it is forwarded to the set of data sources 312. Only data sources that meet the constraints are forwarded a copy of the request. When the request reaches the publishers, it is checked against the data 314. The data that answers the request are extracted 316 and sent back to the QP 318.

The QP collates all of the answers that it receives and presents the results to the subscriber 320.

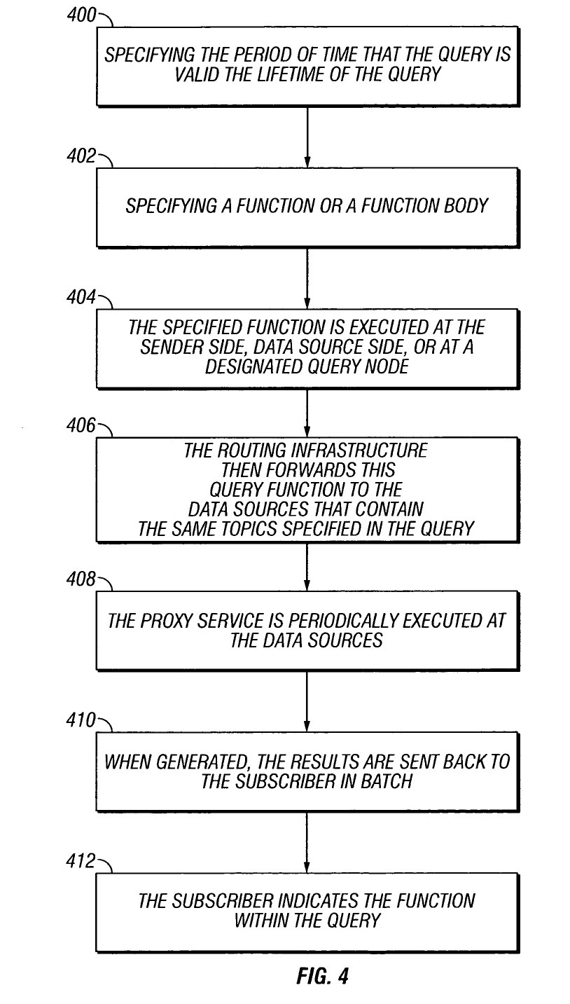

FIG. 4 is a flow diagram showing a method for accessing a virtual content access system built on a content routing network according to the invention.

The method starts from the step of specifying the period of time that the query is valid during the lifetime of the query 400.

The method then proceeds to specify a function or a function body 402. In this way, traditional database queries are extended with an optional additional specification. Then, the specified function is executed at the sender side, data source side, or at a designated query node 404. In general, the method allows data processing functions to be added, in an ad hoc or possibly temporary manner, for purposes of reducing network traffic.

By pushing functionality in the form of declarative steps within one or more functions in conjunction with a query and its query constraints, to this embodiment is enough with an event-based capability. The event is defined by the query constraints and further defined or refined by the declarative steps in the function. The actions to be taken when the event occurs can be further specified as part of the declarative steps within the function.

The routing infrastructure then forwards this query function to the data sources that contain the same topics specified in the query 406. For example, in a relational database, a topic is a table in the relational schema. To execute the request periodically at the data source to test for a positive result, a request proxy in the data source that acts on behalf of the subscriber is built. The proxy service functions as an event. It embeds the subscriber's requirements in the queries. The proxy service is periodically executed at the data sources.

When generated, the results are sent back to the subscriber in a batch 408.

For example, this can be done via an SQL query similar to the following:
SELECT Employee.Name
FROM Employee
WHERE Employee.Dept=“Marketing”
LIFETIME=1 month;

In the case of multi-source events, an event may require information from multiple data sources. The subscriber indicates the function within the query in several ways. The subscriber may not only act on information projected by the query in the select part of the query, but also act on information projected from a subquery. In addition, the subscriber may act on information from a join and a constraint field.

Furthermore, the function may take no parameters in the query but simply provide constraints as a part of the query. It may gather other information directly from the data source nodes that are beyond a data query language, e.g. SQL, such as testing for the existence of known flaws in the data source main processor that could affect the data response.

Queries may specify the function body as well. The function body is written in a declarative interpreted language, such as Java or TCL. The subscriber indicates in the query that a function closure is included. The function body is indicated by either writing the function code as part of the closure statement or by the file containing the function body.

Each data source of the relevant parts of the query message and the function information may comprise a list of constraints, possibly empty, based on which the data source should decide to send information. The constraints comprise the name of the function and the table and the attribute fields.

Each data source of the relevant parts of the query message and the function information, may also comprise a list of return values which the data source should return if the constraints are satisfied. Optionally, a function closure section lists each function along with its function body.

In addition, each data source of the relevant parts of the query message and the function information may comprise a unique message ID and the address of the querying node. In this case, the request is segmented according to its content and forwarded to all the relevant data sources. All the data sources get a subset of the request. Each sub-proxy service executes in the data source according to the event specification in this portion of request. The sub-proxy service is periodically executed in the data sources. When generated, the results are sent back to the subscriber.

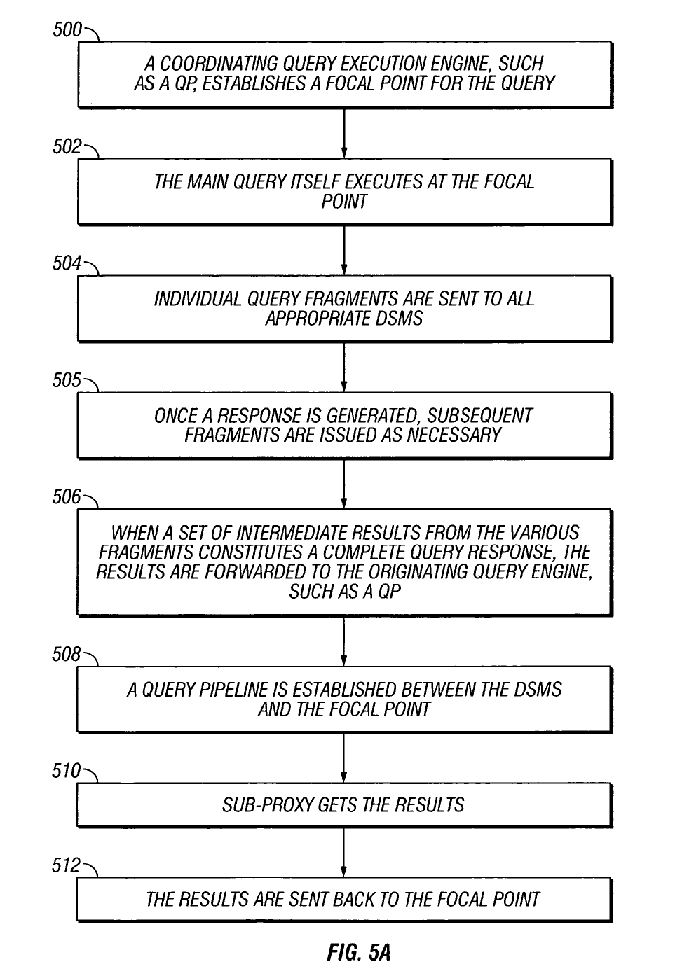

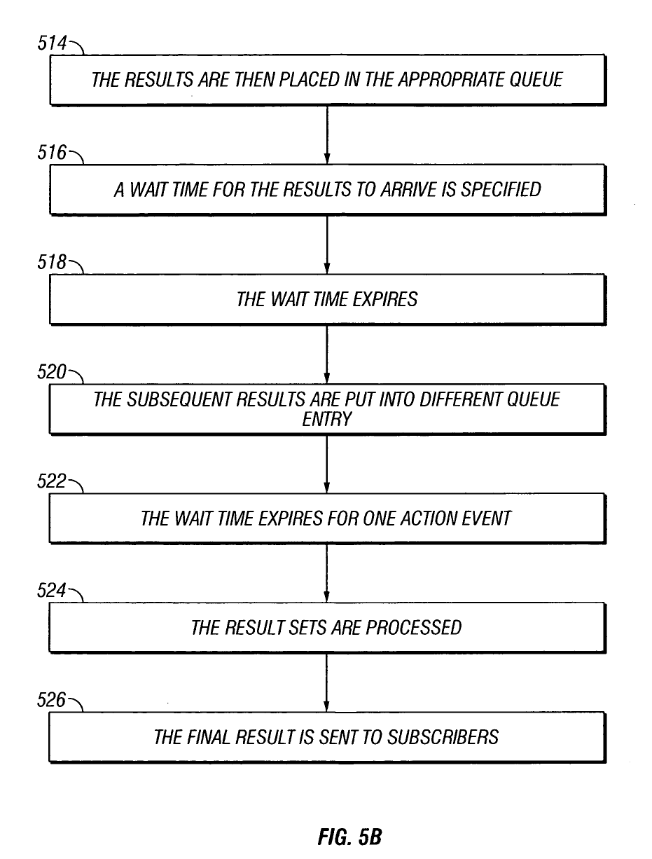

FIG. 5 is a flow diagram showing a method of accessing a virtual content access system built on a content routing network according to the invention. A coordinating query execution engine, such as a QP, establishes a focal point for the query 500. This focal point is either the QP itself or another query execution engine situated within the distributed content-based network system, such as a designated query node.

The main query itself executes at the focal point 502. Optionally, a specific data source may be specified by the subscriber. For example, an extended SQL query is shown below:
SELECT Employee.Name
FROM Employee
WHERE Employee.Dept=“Marketing”
DATA_SOURCE_ID=“Main_HQ_Computer”
LIFETIME=1 month;

Individual query fragments are sent to all appropriate DSMs 504. These fragments may sent in parallel in the case of parallel execution of the underlying query subtrees. In the case of serial execution, the fragments pertaining to the first subtree are distributed to the DSMs. Once a response is generated, subsequent fragments are issued as necessary 505.

When a set of intermediate results from the various fragments constitutes a complete query response, the results are forwarded to the originating query engine, such as a QP 506. Several federated and hierarchical focal points that govern the actions of multiple functions or join points within a query may exist.

To govern the flow of the data from the DSMs and through the query execution engine, a query pipeline is established between the DSMs and the focal point 508. This pipeline essentially encapsulates the query's abstract syntax tree. In addition, the pipeline comprises subscriber-definable windows of time to govern the validity of data within the pipeline. The window defines if the two related events together constitute a valid event or not. If the events fall within the time window, then they are related and constitute a valid event. If the events fall outside the window, then they do not constitute a valid event.

Information about the pipeline is maintained in a soft state within the focal point and within the DSMs. This pipeline soft-state is periodically refreshed by the focal point. The soft-state specifies the address of the focal point, the query fragment, the governing time window, and (within the focal point) the execution path for the abstract syntax tree for the query.

Each request proxy is divided into a set of sub-proxies executed in the individual data sources. Each sub-proxy has a unique proxy ID (SPID) associated with the original proxy ID (PID). The SPID has the same prefix as the PID. A sub-proxy service with the same SPID can execute on more than one data source if the data sources satisfy its requirements.

Each PID has its own queue in the focal point. The entry of the queue is a set of temporary tables.

When sub-proxy gets the results 510, the results are sent back to the focal point 512. The results are then placed in the appropriate queue 514.

A wait time for the results to arrive is specified 516. When the wait time expires 518, the subsequent results are put into different queue entry 520. Basically, the sub-proxy results fill the corresponding time-table.

When the wait time expires for one action event 522, the result sets are processed 524. The final result is sent to subscribers 526. The result can be a partial result if some sub-proxy cannot send its results.

When there is more than one event-based subscription, each of them has its own PID with its own queue in focal point. Each sub-proxy result finds its own PID queue and puts its results there. To make efficient use of memory when sending a result to subscriber, the queue entry is declaimed and reused. When a proxy request finishes its run or a subscriber deletes it, the queue is declaimed and the memory is reused.

When a request is added to the system, if it is a single query, the request is executed once. The result is sent to subscriber. If it is event-based, the request is sent to the data sources. The proxy service is created in data sources. Each router (DQR) cache a list of PIDs or SPID it serves.

The subscriber can only delete an event-based request. When a DQR gets the deletion message and finds matched PID/SID, it forwards the request to the data source manager. Each data source manager has a list of processes which execute the proxy services. The DSM terminates the process and sends the status to the DR. The DR sends the message upstream to the subscriber.

Updating an event-based request is equivalent to deleting the old proxy service and issuing a new proxy service. If there are sub-proxy services in the data sources, all of them are terminated.

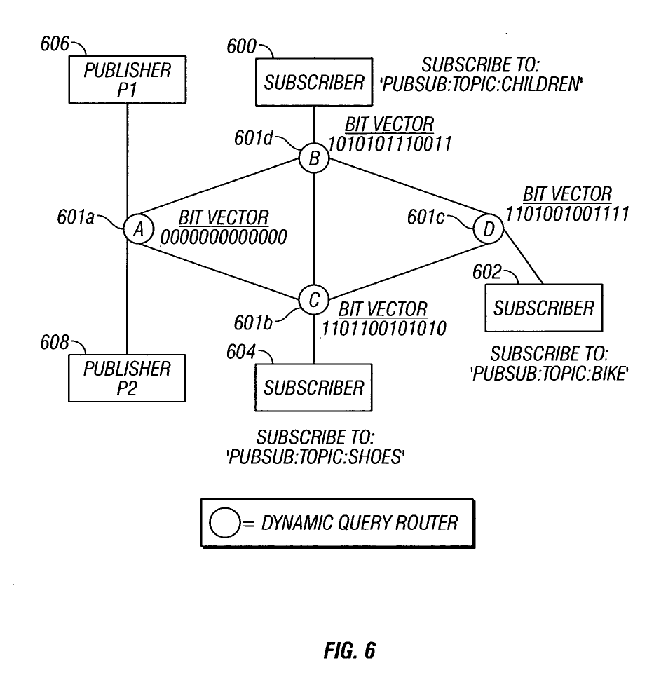

FIG. 6 is block diagram showing a system for subscribing to a topic based on the virtual content access system built on a content routing network according to the invention. The system receives information on any topic on dynamic query routers 601a, 601b, 601c, and 601d.

The requester of information, i.e. a subscriber 600, 602, 604, indicates his interests to receive any information about a particular topic without any restriction on the identity of the publisher 606, 608 by using the receiver characteristic routing (CR) library. The subscriber 600, 602, 604 declares a characteristic that identifies the desired topic.

For example, the characteristic are defined as “PubSub:Topic:Bike.” In this example, the subscriber 602 is declaring an unconstrained interest in the topic “Bike.” The topic characteristic is indexed and put into DQR routing tables.

Queues are needed for disconnected subscribers or for slow subscribers. The message queues store pushes messages until the subscriber 602 asks for them. A message queue is a separate execution component. The message queue must be placed on an online computer. The subscriber 602 registers with the message queue. The message queue then declares characteristics on behalf of all registered subscribers. The subscriber 602 pushes messages to the message queue first 610.

The subscriber 604 polls the message queue for new messages.

Often, a publisher and subscriber authentication and access control are necessary for secure publication and subscription infrastructure. In the invention, a security system can be implemented by configuring the authentication and access control at the administration dashboard. A PubSub API is implemented as a wrapper around the CR library. Authentication occurs through the library and the administration dashboard. Access control is downloaded to the PubSub API and enforced at API level.

One of the access control strategies is effected by granting certain topics. For example, a subscriber can publish or subscribe to specific topics or sources only. Alternatively, a subscriber can publish or subscribe to any topic or source, except for those that are denied.

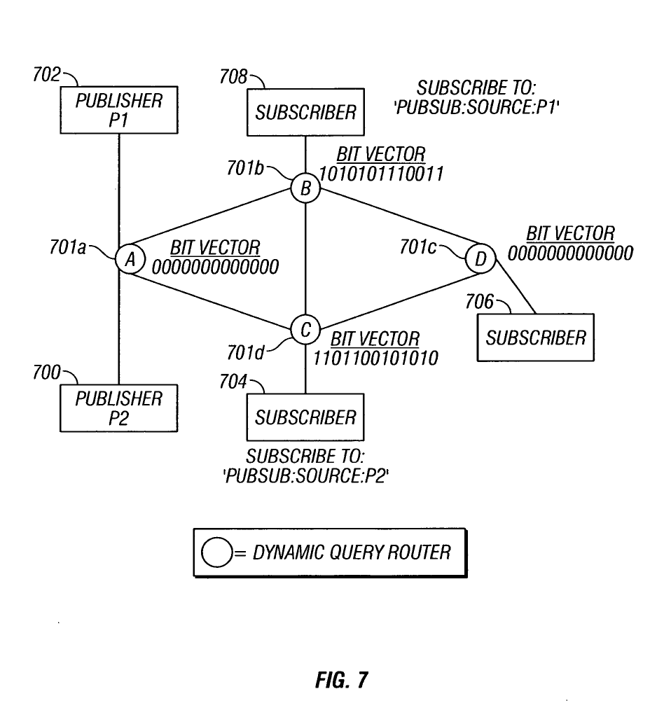

FIG. 7 is a block diagram showing a system for subscribing to a source on the virtual content access system built on a content routing network according to the invention. The system receives information on any topic that is transmitted by the specified publisher 700 or 702 on dynamic query routers 701a, 701b, 701c, and 701d.

When subscribing to a specific source, a topic is indicated by declaring a characteristic that identifies the desired source by a publisher 700 or 702 using the receiver characteristic routing library. For example, the characteristic is defined as:
“PubSub:Source:P2”

In this example, the subscriber 704 is declaring an unconstrained interest in the source with ID “P2.”

Queues are needed for disconnected the subscriber or for slow subscribers. The message queues store pushes messages until the subscriber 704 asks for them. A message queue is a separate execution component. The message queue must be placed on an online computer. The subscriber registers with the message queue. The message queue then declares characteristics on behalf of all registered subscribers. The subscriber 704 pushes messages to the message queue first.

The subscriber polls the message queue for new messages.

Often, the publisher 700, 702 and the subscriber 704, 706, 708 authentication and access control are necessary for secure publication and subscription infrastructure. In the invention, a security system can be implemented by configuring the authentication and access control at the administration dashboard. A PubSub API is implemented as a wrapper around the CR library. Authentication occurs through the library and the admin dashboard. Access control is downloaded to the PubSub API and enforced at API level.

One of the access control strategies is effected by granting certain topics. For example, a subscriber can publish or subscribe to specific topics or sources only. Alternatively, a subscriber can publish or subscribe to any topic or source, except for those that are denied.

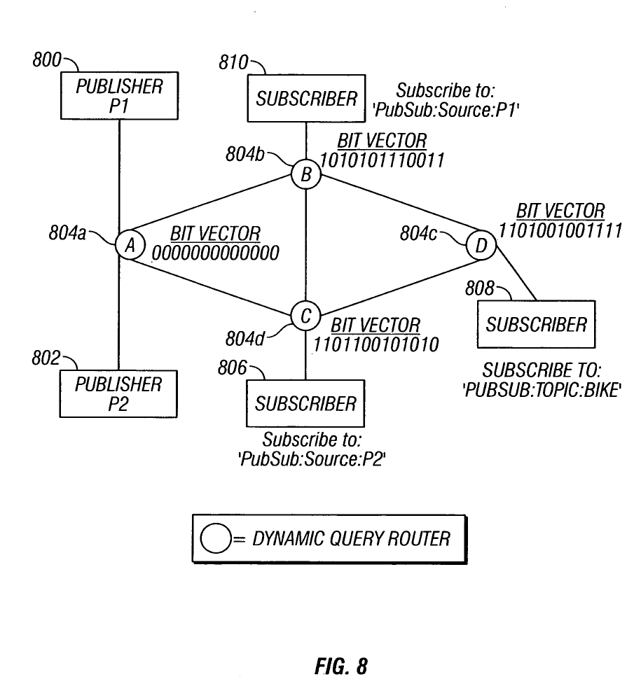

FIG. 8 is a block diagram showing a system of mixed subscription on the virtual content access system built on a content routing network according to the invention. The system receives information on any topic that is transmitted by the specified publisher 800 or 802 on dynamic query routers 801a, 801b, 801c, and 801d.

When subscribing to a specific source, a topic is indicated by declaring a characteristic that identifies the desired source by a publisher 800 or 802 using the receiver characteristic routing library. For example, the characteristic is defined as:
“PubSub:Source:P2”

In this example, the subscriber 806 declares an unconstrained interest in the source with ID “P2.”

Queues are needed for disconnected subscribers or for slow subscribers. Message queues store pushes messages until the subscriber 806 asks for them. A message queue is a separate execution component. The message queue must be placed on an online computer. The subscriber registers with the message queue. The message queue then declares characteristics on behalf of all registered subscribers. The subscriber 806 pushes messages to the message queue first.

The subscriber 806 polls the message queue for new messages.

When subscribing to a specific topic, the requester of information, i.e. a subscriber 806, 808, 810 indicates his interests in receiving any information about a particular topic without any restriction on the identity of the publisher 800, 802 by using the receiver characteristic routing library. The subscriber 806, 808, 810 declares a characteristic that identifies the desired topic.

For example, the characteristic are defined as “PubSub:Topic:Bike.” In this example, the subscriber 808 is declaring an unconstrained interest in the topic “Bike.” The topic characteristic is indexed and put into DQR routing tables.

Queues are needed for disconnected subscribers or for slow subscribers. The message queues store pushes messages until the subscriber 808 asks for them. A message queue is a separate execution component. The message queue must be placed on an online computer. The subscriber 808 registers with the message queue. The message queue then declares characteristics on behalf of all registered subscribers. The subscriber 808 pushes messages go to the message queue first.

The subscriber 808 polls the message queue for new messages.

After users issue either source-based or topic-based subscriptions, each local DQR's bit vector contains the encoding of all of the subscriptions for the computers connected to that router.

The DQRs 801a, 801b, 801c and 801d propagate knowledge of these subscriptions using their network routing protocols and construct a routing table with this information. A simplified example of the routing table is contained in Error! Reference source not found.

TABLE 1

| | Next Edge on Shortest Path to | Destination |
|---|---|---|
| Destination | Destination | Content |
| A | Self | 0000000000000 |
| B | A → B | 1010101110011 |
| C | A → C | 1101100101010 |
| D | A → B | 1101001001111 |

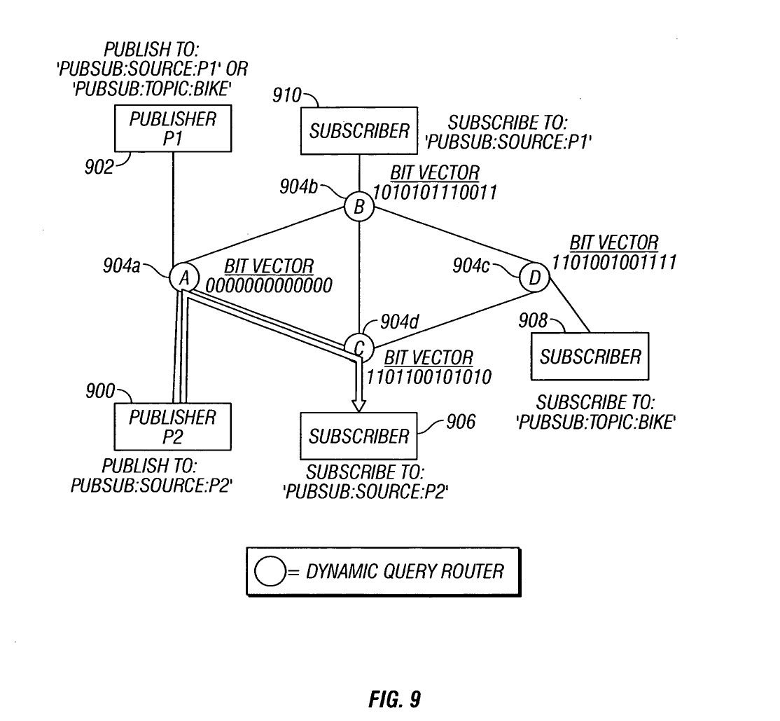

FIG. 9 is a block diagram showing a system for publishing to source subscribers on the virtual content access system built on a content routing network according to the invention. A system according to this embodiment of the invention comprises the dynamic query routers 904a, 904b, 904c, and 904d.

A publisher 800, 802 transmits information using a sender characteristic routing library to specific topic or source characteristics. The DQRs 804a, 804b, 804c, 804d transport the information to subscribers 806, 808, 810 who have declared the same topic or source characteristics.

For example, when publishing as a source, the publisher 800 with ID “P2” uses the destination characteristic, “PubSub:Source:P2.” This allows the published information to be propagated correctly to all subscribers, who wish to receive information from this publisher 800.

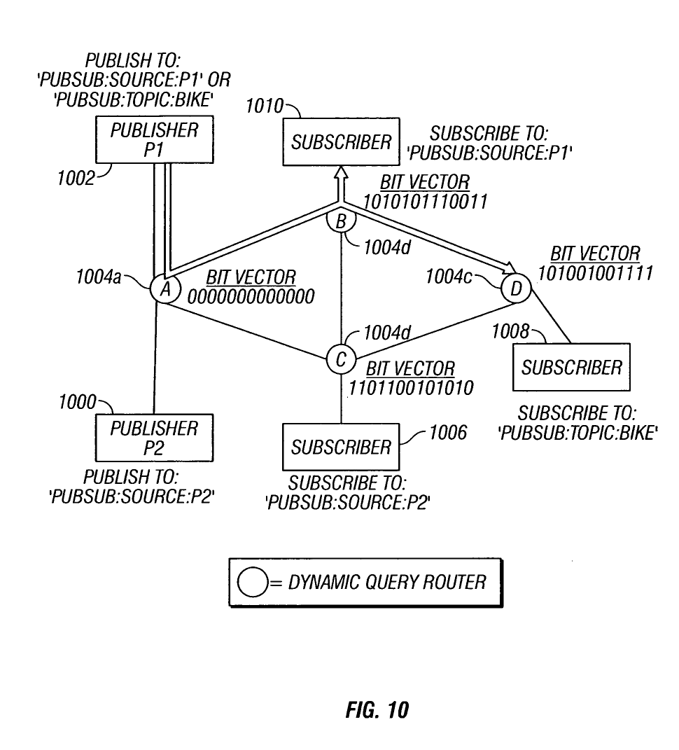

FIG. 10 is a block diagram showing a system of publishing to topic subscribers on the virtual content access system built on a content routing network according to the invention. A system according to this embodiment of the invention comprises dynamic query routers 1004a, 1004b, 1004c, and 1004d.

Publishing to a topic requires the union of two destination characteristics, i.e. one to designate the topic characteristic and one to specify the source characteristic. For example, when publishing to the topic “Bike,” the publisher 1002 with ID “P1” uses both the destination characteristic, “PubSub:Source:P1” 1010 and the destination characteristic, “PubSub:Topic:Bike” 1008.

Both of these destination characteristics are contained within the same message packet with a logical OR defined between them. The published information in a single message is thus propagated correctly in a one-to-many fashion to all subscribers who wish to receive either the topic or source-based information from the publisher 1002.

In the invention, different kinds of requests are in the form of queries or advanced queries having function blocks. To generate the bit vectors efficiently, index keys are identified in queries and encoded. The data sources scan the database and generate the bit vector based on the index keys as well. The queries or advanced queries can refer to single value data or a range data.

The hash-based indexes used by the content-based routing network are designed to search and find specific discrete objects quickly. However, the random nature of hash functions precludes any kind of ordered search. For instance, unlike the common database data structure called B-Trees, which allows for ordered ascending or descending searches, a hash-based index cannot service a range request such as “all values>100.”

Range requests are common in many applications and are often used as a way of detecting thresholds. For instance, if the number of item stock in a store is less than ten, then this may indicate that the stock is about to run out.

Data grouping can be used as a way of enabling hash-based indexes to handle range requests. At the same time, data grouping lends itself as a way of reducing information content in the summary bit vector, and as a way of smoothing out continuous dynamic changes in values. This improves performance by reducing the memory requirements and reducing the number of distinct values that need to be indexed and monitored.

Data grouping requires changes in the global schema, DSM, DQR, and QP.

The data grouping definitions reside in the global schema because the global schema is referenced by all QPs and DSMs. For a particular table and attribute, data items that need to be indexed are grouped into ranges or sets. Each range or set is assigned a group identifier.

The DSM indexes the data groups for that table and attribute during profiling and during rescanning. It references the global schema to determine if it should index discrete values directly or as part of a group. If the particular table and attribute being indexed is designated as a data group, then each discrete value is mapped to a specific data group. Instead of indexing each individual data item, the corresponding data group identifier is indexed instead.

When a new data value falls into a data group that has not be previously indexed, then that data group's identifier is indexed.

If all of the data values in a previously indexed data group are deleted, then that data group's identifier is removed from the index.

The changes in the QP are similar to the changes in the DSM. Assuming a table A with columns i and j and a data value v, then when a query makes a range request, the QP needs to map that request into one or more data groups, as shown below:
A.i=v—in this case, the value v is mapped to its single corresponding data group;
A.i>v—in this case, the value v is mapped to its corresponding data group and all groups that have values greater than v;
A.i<v—in this case, the value v is mapped to its corresponding data group and all groups that have values less than v.

When creating the characteristics for query routing purposes, the data groups' identifiers as the routing characteristics are used. The characteristics for those groups in its query message are included.

For example, a user can specify a discrete value in query, such as A.j=‘Gold,’ which translates directly into a routable characteristic: “A:j:Gold.” However, when the user wants to perform range requests, such as A.i>100, then the QP maps “A.i>100” into the appropriate set of buckets “B3 or B4.” The QP specifies the routing characteristics as “A:i:B3” OR “A:i:B4.”

Currently, the DQR only routes a query based on a logical AND of the routing characteristics included with the query message. To handle range requests, the DQR must handle logical ORs between routing characteristics as well. To apply the logical ORs and ANDs in the proper sequence, the characteristics is given in disjunctive normal form, i.e. logical ANDs takes precedence over logical ORs.

For example, given the query:
Select A.i
From A
Where A.j=‘Gold’ AND A.i>100;
   The above query translates into the following routing characteristics:
(“A:j:Gold” AND “A:i:B3”) OR (“A:j:Gold” AND “A:i:B4”)

Some data sources have almost the full range of distinct values such as data warehouses, while other data sources are not reachable for data update rescans. In both cases, the cost of providing continuous index updates from the sources outweighs the benefit derived from the updates. Therefore, it is preferable to eliminate the update traffic. Yet, at the same time, all of the queries continue to reach the data sources.

To eliminate the update traffic while, at the same time, still assuring that queries reach them, changes must be made to the data source manager (DSM). Additionally, for extra memory savings, changes are made to the dynamic query route.

The DSM has a parameter that allows it to set its summary bit vector, which represents its data content. The same parameter turns off all data rescans so that no summary bit vector updates take place. This has the effect of causing all queries to be routed to DSM because the summary bit vector essentially says that it contains all of the unique data values. Because the data source is already receiving all of the queries all of the time, updating information is not necessary. The DSM can be turned off safely.

For extra memory and transmission savings, a flag can be used in the memory-based summary bit vector data structure and in the summary bit vector transmission packets. This flag indicates that this summary bit vector contains all ones. With this flag, there is no need to set aside the memory or transmission bandwidth to represent a bit vector that is all ones.

When a flag indicates that the summary bit vector contains all ones, the DQR detects and understands the flag in the transmitted summary bit vector packets, and changes its internal summary bit vector data structures to incorporate the flag as necessary.

In many existing information systems, data replication is used to reduce response times for data access. Data are replicated in whole or in part from a primary data source to one or more secondary data sources. The replicated information may then be augmented at the secondary data source with additional data that serves a regional, departmental, or functional purpose.

When connecting all of these data sources together with a distributed data management system, it is necessary to make distinctions between primary and secondary data sources. By making such distinctions, it is possible to reduce control and run-time overhead. Instead of routing a query to all replicated instances of the same data and returning multiple identical sets of results, it is more efficient to interact only with the primary data source for most queries, and to interact with the secondary data sources only when the primary fails or when the user specifically states to include both.

Changes must be made to the DSM and the QP to distinguish between the two types of data sources.

The act of designating a data source as primary or secondary is the same as designating them as members of two distinct and disjoint groups. For the purposes of the application and without loss of generality, the group of primary data sources is given the identifier PRIMARY and the group of secondary data sources is given the identifier SECONDARY.

Further levels of data replication are a straightforward extension. In the invention, an identifier is known as a characteristic and is represented as a specific arbitrary-length string. The words “identifier” and “characteristic” are used interchangeably.

When the data source is originally configured, it is designated as a member of the PRIMARY or SECONDARY groups at the different object levels: node, database, table, or column. By default, all nodes, databases, tables, and columns are PRIMARY.

When designating an object as PRIMARY or SECONDARY, it is the equivalent of assigning a metadata attribute to them. The string “Metadata_Attribute_Name=Attribute_Value” is appended to the node's, database's, table's, or column's normal characteristic. For instance, attaching a metadata attribute to a column is as follows:
“Global_Schema_Name:Table_Name:Column_Name:Metadata_Attribute_Name=Attribute_Value”.

All of these characteristics are indexed by the DQRs and are routable.

The metadata attribute name for designating an object to be either PRIMARY or SECONDARY is “Level”. The value of the attribute is the replication level designated. The following object characteristics are created:
1. Node—the entire computing node and all of the data within it is designated as PRIMARY or SECONDARY. Nodes that are PRIMARY exports the characteristic “Level=PRIMARY” and all nodes that are SECONDARY exports the characteristic “Level=SECONDARY.”
2. Database—the specific database instance is designated as PRIMARY or SECONDARY. In the invention, a database instance is represented by a global schema. Database instances that are PRIMARY export the characteristic “Global_Schema_Name:Level=PRIMARY” and database instances that are SECONDARY export the characteristic “Global_Schema_Name:Level=SECONDARY.”
3. Table—the specific table within a specific database instance is designated as PRIMARY or SECONDARY. Table instances that are PRIMARY export the characteristic “Global_Schema_Name:Table_Name:Level=PRIMARY” and table instances that are SECONDARY export the characteristic “Global_Schema_Name: Table_Name:Level=SECONDARY.”
4. Column—the specific column pertaining to a specific table within a specific database instance is designated as PRIMARY or SECONDARY. Column instances that are PRIMARY export the characteristic “Global_Schema_Name:Table_Name:Column_Name:Level=PRIMARY” and column instances that are SECONDARY export the characteristic “Global_Schema_Name: Table_Name: Column_Name:Level=SECONDARY.”

Query Processors by default route queries to PRIMARY data sources. A user can override the default through a parameter setting, such as an SQL variable. The user can set the parameter to be:
PRIMARY, which queries only primary data sources;
SECONDARY—which queries only secondary data sources; or
ALL—which queries all data sources.

To distinguish between primary and secondary data sources, metadata characteristics specifying the desired replication level are included in the list of routing characteristics, in addition to the usual characteristics.

For instance, assuming a global schema object Z that is located on nodes A and B, then B is a replication of A. Therefore, B is the SECONDARY for A.

A exports the following characteristics:
“Z”
“Z:Level=PRIMARY”

B exports the following characteristics:
“Z”
“Z:Level=SECONDARY”

When querying for primary global schema objects Z, the QP uses the following list of routing characteristics to route the query:
“Z”
“Z:Level=PRIMARY”

Specifying the additional primary metadata characteristic for Z forces the query to be routed only to data sources that have primary copies of Z.

Likewise, when querying for secondary global schema objects Z, the QP uses the following list of routing characteristics to route the query:
“Z”
“Z:Level=SECONDARY”

As above, specifying the additional secondary metadata characteristic for Z forces the query to be routed only to data sources that have secondary or replicated copies of Z.

When querying for all global schema objects Z, the QP uses the typical list of routing characteristics to route the query. In this case it is:
“Z”

All data source objects that are SECONDARY should also expose the identifier of the PRIMARY object using the metadata attribute name “Parent”. The value of the metadata attribute is the identifier of the node that contains the PRIMARY object.

When a QP is told by the underlying content-based routing network that specific PRIMARY data sources did not respond to a query, the QP has the option of manually or automatically reissuing the query with the desired object's identifier as the value to the “Parent” metadata attribute for that object.

For instance, assume a global schema objects Z that is located on nodes A, B, C, and D. B is the SECONDARY for A. D is the SECONDARY for C.

A exports the following characteristics:
“Z”
“Z:Level=PRIMARY”

B exports the following characteristics:
“Z”
“Z:Level=SECONDARY”
“Z:Parent=A”

C exports the following characteristics:
“Z”
“Z:Level=PRIMARY”

D exports the following characteristics:
“Z”
“Z:Level=SECONDARY”
“Z:Parent=C”

The QP initially issues a query for primary copies of Z. In this case, the query is routed to A and C. When A does not respond, the QP has the option of reissuing the query with the additional characteristics:
“Z:Level=SECONDARY”
“Z:Parent=A”

These characteristics forces the query to be routed to B.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A method for information management of a network database having distributed data sources, comprising the steps of:
decomposing a query into at least one network message for transmission using characteristic routing over a network only to data sources, that are relevant to said query, said query specifying at least one data source;
receiving a reply message in response to said network message over said network; and
generating a result for said query from said reply message.

2. The method of claim 1, wherein said query is received in a database language.

3. The method of claim 2, wherein said generated result is in said database language.

4. The method of claim 2, wherein said query further specifies a period of time during which said query is valid.

5. The method of claim 2, wherein said query specifies no data-specific constraints on returned values for one or more requested topics.

6. The method of claim 2, wherein said query further specifies at least one data specific constraint on returned values on one or more requested topics.

7. The method of claim 2, wherein said query requests an immediate response.

8. A machine readable medium containing instruction data which when executed on a data processing system, causes the system to perform a method for information management of a network database having distributed data sources, the method comprising the steps of:
decomposing a query into at least one network message for transmission using characteristic routing over a network only to data sources that are relevant to said query, said query specifying a period of time during which the query is valid, and said query specifying no data-specific constraints for returned values on one or more requested topics;
receiving a reply message in response to said network message over said network; and
generating a result for said query from said reply message.

9. The medium of claim 8, wherein said query is received in a database language and said generated result is in the database language.

10. The medium of claim 8, wherein said query specifies at least one data source.

11. The medium of claim 8, wherein said query specifies no specific data source.

12. The medium of claim 8, wherein said data sources group data into any of ranges and sets.

13. The medium of claim 12, wherein said query specifies a range request.

14. A system for information management of a network database having distributed data sources, comprising:
means for decomposing a query into at least one network message for transmission using characteristic routing over a network only to data sources that are relevant to said query, said query either specifying at least one data source or requesting data from multiple data sources within a specific period of time;
means for receiving a reply message in response to said network message over said network; and
means for generating a result for said query from said reply message.

15. The system of claim 14, wherein said query is received in a database language.

16. The system of claim 15, wherein said generated result is in said database language.

17. The system of claim 15, wherein said query further specifies a period of time during which said query is valid.

18. The system of claim 15, wherein said query specifies no data-specific constraints on returned values for one or more requested topics.

19. The system of claim 15, wherein said query further specifies at least one data-specific constraint on returned values for one or more requested topics.

20. The system of claim 15, wherein said query requests an immediate response.
